(19) United States
(12) Patent Application Publication
(10) Pub. No.: US 2024/0039000 A1
(43) Pub. Date: Feb. 1, 2024

(54) CURRENT COLLECTOR, ELECTRODE SHEET, ELECTRODE ASSEMBLIE, BATTERY CELL, BATTERY, AND ELECTRIC APPARATUS

(71) Applicant: Contemporary Amperex Technology Co., Limited, Ningde City, Fujian (CN)

(72) Inventors: Xingxing LI, Ningde City, Fujian (CN); Zhiming CHEN, Ningde City, Fujian (CN); Xiaoteng HUANG, Ningde City, Fujian (CN)

(73) Assignee: Contemporary Amperex Technology Co., Limited, Ningde City, Fujian (CN)

(21) Appl. No.: 18/123,366

(22) Filed: Mar. 20, 2023

Related U.S. Application Data
(63) Continuation of application No. PCT/CN22/83779, filed on Mar. 29, 2022.

(30) Foreign Application Priority Data
Oct. 28, 2021 (CN) 202122614507.4

(51) Int. Cl. H01M 4/66; H01M 10/04; H01M 50/103

(52) U.S. Cl. CPC H01M 4/667; H01M 4/662; H01M 4/663; H01M 10/0431; H01M 50/103; H01M 2220/20

(57) ABSTRACT

The present application relates to the technical field of batteries, and in particular to a current collector, an electrode sheet, an electrode assembly, a battery cell, a battery and an electric apparatus. The current collector includes: a support layer; and a conductive layer on at least one of two opposite sides of the support layer, where when the support layer is heated and shrinks, the conductive layer shrinks with the support layer to form a hole around a heated portion, the conductive layer includes a first conductive layer in contact with the support layer, and the first conductive layer is a granular conductive layer. On this basis, the safety performance can be improved.

### CROSS-REFERENCE TO RELATED APPLICATIONS

This application is a continuation of International Application No. PCT/CN2022/083779, filed on Mar. 29, 2022, which claims priority to Chinese Patent Application No. 202122614507.4, filed on Oct. 28, 2021, both of which are hereby incorporated by reference in their entireties.

### TECHNICAL FIELD

The present application relates to the technical field of batteries, and in particular to a current collector, an electrode sheet, an electrode assembly, a battery cell, a battery and an electric apparatus.

### BACKGROUND

With the rapid development of electric apparatus such as electronic products and electric vehicles, batteries have been widely used. However, batteries are prone to short-circuit, causing a thermal runaway, affecting operational safety.

### SUMMARY

The present application aims to provide a current collector, an electrode sheet, an electrode assembly, a battery cell, a battery and an electric apparatus with improved safety performance.

To achieve the above object, the present application provides a current collector, including:
a support layer; and
a conductive layer on at least one of two opposite sides of the support layer,
where when the support layer is heated and shrinks, the conductive layer shrinks with the support layer to form a hole around a heated portion,
the conductive layer includes a first conductive layer in contact with the support layer, and the first conductive layer is a granular conductive layer.

Under the action of the support layer and the conductive layer, the current collector can rapidly cut off the failure circuit to prevent a thermal runaway, and therefore, the safety performance can be effectively improved.

In some embodiments, the granular conductive layer includes a metal particle layer. On this basis, the current collector can be made to have good electrical conductivity.

In some embodiments, the metal particle layer includes a copper particle layer, an aluminum particle layer, a gold particle layer, a silver particle layer, or an alloy particle layer. As such, a conductivity performance of the current collector can be effectively improved.

In some embodiments, a resistivity of an alloy in the alloy particle layer is less than or equal to 30·10⁻⁰ Ω·m. In this way, the current collector can be made to have better electrical conductivity.

In some embodiments, the first conductive layer is sprayed on the support layer. On this basis, the granular conductive layer can be conveniently composited on the support layer, and after the spraying, the granular conductive layer can be firmly attached to the support layer.

In some embodiments, the conductive layer includes a second conductive layer electrically connected to a surface of the granular conductive layer facing away from the support layer. On this basis, the ability of the conductive layer to conduct electricity can be improved.

In some embodiments, the second conductive layer is bonded to the first conductive layer. On this basis, the first conductive layer is easily connected to the second conductive layer, the connection firmness is strong, and at the same time, the electrical connection relationship between the first conductive layer and the second conductive layer is easy to realize.

In some embodiments, the second conductive layer includes a graphite layer. On this basis, the conductivity performance of the conductive layer can be improved more effectively.

In some embodiments, a conductivity of the conductive layer is 10⁴˜10⁵ S/cm. As such, the conductive layer can better satisfy the conductivity requirements of the current collector, and can effectively prevent the battery cell from generating excessive heat during a conventional charging or discharging processes.

In some embodiments, a melting point of the support layer is less than or equal to 120° C. On this basis, the support layer is more likely to melt and shrink before other portions are melted, cutting off the failure circuit. Therefore, the prevention of the thermal runaway can be more reliable and the safety performance can be more effectively improved.

In some embodiments, the support layer is a support film. As such, the current collector not only has good safety performance, but also has strong structural stability.

In some embodiments, the support layer is made of an organic polymer material. The support layer made of the organic polymer material can rapidly cut off the failure circuit when necessary, prevent a thermal runaway and improve the safety performance.

In some embodiments, the support layer is a polyethylene film. The polyethylene film can not only effectively prevent a thermal runaway, but also improve the flex resistance of the current collector.

An electrode sheet provided in the present application includes an active material, and further includes the current collector according to an embodiment of the present application, where the active material is arranged on the surface of the current collector.

Due to the inclusion of the current collector according to an embodiment of the present application, the safety performance of the electrode sheet is higher.

The electrode assembly provided in the application includes:
a positive electrode sheet; and
a negative electrode sheet;
where the positive electrode sheet and/or the negative electrode sheet are the electrode sheet according to an embodiment of the present application.

Due to the inclusion of the current collector according to an embodiment of the present application, the safety performance of the electrode assembly is higher.

The battery cell provided in the present application includes a housing, and further includes the electrode assembly according to an embodiment of the present application, where the electrode assembly is arranged in the housing.

Due to the inclusion of the current collector according to an embodiment of the present application, the safety performance of the battery cell is higher.

The battery provided in the present application includes a receiving case, and further includes the battery cell according to an embodiment of the present application, where the battery cell is arranged in the receiving case.

Due to the inclusion of the current collector according to an embodiment of the present application, the safety performance of the battery is higher.

The electric apparatus provided in the present application includes the battery or the battery cell according to an embodiment of the present application, where the battery cell is configured to provide electric power to the electric apparatus.

Due to the inclusion of the current collector according to an embodiment of the present application, the safety performance of the electric apparatus is higher.

Based on the current collector provided in the embodiments of the present application, when a short circuit occurs during the operation of the battery cell, the support layer can be melt and shrink because of the influence of the high temperature at the failure position, and drive the conductive layer to shrink with it to form the hole around the heated portion, so as to cut off the failure circuit and prevent the occurrence of the thermal runaway. In addition, the conductive layer includes the granular conductive layer, compared with conductive layers of other forms, the granular conductive layer is more likely to shrink with the support layer when the support layer is heated and shrinks. As such, the circuit can be more rapidly cut off and the thermal runaway can be more timely prevented when a short-circuit accident occurs. Therefore, the safety performance of the battery can be improved more effectively.

Other features and advantages of the present application will become apparent from the following detailed description of exemplary embodiments thereof, which proceeds with reference to the accompanying drawings.

### BRIEF DESCRIPTION OF THE DRAWINGS

In order to explain embodiments of the present application or the technical solutions in the prior art more clearly, the following is a brief introduction to the drawings used in the embodiments or the description of the prior art. Obviously, the drawings in the description below are only some embodiments of the present application, and a person skilled in the art would have been able to obtain other drawings according to these drawings without involving any inventive effort.

FIG. 1 is a schematic structural diagram of an electric apparatus according to an embodiment of the present application.

FIG. 2 is an exploded view of a battery according to an embodiment of the present application.

FIG. 3 is an exploded view of a battery cell according to the embodiment of the present application.

FIG. 4 is a structural diagram of an electrode assembly according to an embodiment of the present application.

FIG. 5 is a schematic view of a current collector according to an embodiment of the present application.

FIG. 6 is a schematic illustration of the principle of the current collector preventing a thermal runaway according to an embodiment of the present application.

### REFERENCE NUMERALS

100: Electric apparatus; 101: Vehicle; 102: Controller; 103: Power device; 104: Motor; 105: Body;
10: Battery;
20: Battery cell; 201: Electrode assembly; 202: Housing; 203: Casing; 204: End cap; 205: Adapter; 206: Electrode terminal; 207: Tab; 208: Spacer;
30: Receiving case; 301: Case body; 302: Case cover;
1: Positive electrode sheet;
2: Negative electrode sheet;
3: Diaphragm;
4: Electrode sheet;
5: Current collector; 51: Support layer; 511: Support film; 512: Polyethylene film; 52: Conductive layer; 521: Granular conductive layer; 522: Graphite layer; 523: Metal particle layer; 524: First conductive layer; 525: Second conductive layer; 526: Hole;
6: Active material;
7: Short-circuit initiating piece; 71: Puncture needle.

### DETAILED DESCRIPTION

Technical solutions in embodiments of the present application will be described clearly and completely below in combination with the drawings of the embodiments of the application. Obviously, the described embodiments are only part of the embodiments of the application, not all of the embodiments. The following description of at least one exemplary embodiment is actually only illustrative and in no way serves as any limitation on the application and its application or use. Based on the embodiments in the application, all other embodiments obtained by those who skilled in the art without carrying out creative work belong to the protection scope of the application.

Techniques, methods, and apparatus known to one of ordinary skill in the art may not be discussed in detail, but should be considered part of the specification where appropriate.

In the description of this application, it should be understood that the orientation or positional relationship indicated by orientation words such as “front, back, up, down, left, right”, “horizontal, vertical, perpendicular, horizontal” and “top and bottom” is usually based on the orientation or positional relationship shown in the drawings, which is only for the convenience of describing this application and simplifying the description. Without contrary explanation, these positional words do not indicate and imply that the device or element must have a specific position or be constructed and operated in a specific location, so they cannot be understood as limiting the protection scope of the application. The positional words “inside and outside” refer to the inside and outside of the contour relative to each component itself.

In the description of the present application, it is to be understood that the use of the terms “first”, “second” and the like to define a component is merely to facilitate the distinction between the corresponding components. If not otherwise stated, the terms above have no particular meaning and therefore should not be construed as limiting the scope of the present application.

In addition, the technical features involved in the different embodiments of the present application described below can be combined with each other as long as they do not conflict with each other.

At present, batteries have been widely used. Batteries are not only used in energy storage power systems such as hydraulic, fire, wind and solar power plants, but also widely used in electric vehicles such as electric bicycles, electric motorcycles, electric cars, military equipment and aerospace. As battery applications continue to expand, their performance requirements continue to improve.

Safety performance is an important performance index of a battery. During use of the battery, as well as during routine maintenance, it is necessary to prevent thermal runaway accidents. How to prevent the thermal runaway and improve the safety performance is always a difficult problem.

In order to improve the safety performance of a battery, the present application provides a current collector, an electrode assembly, a battery cell, a battery and an electric apparatus.

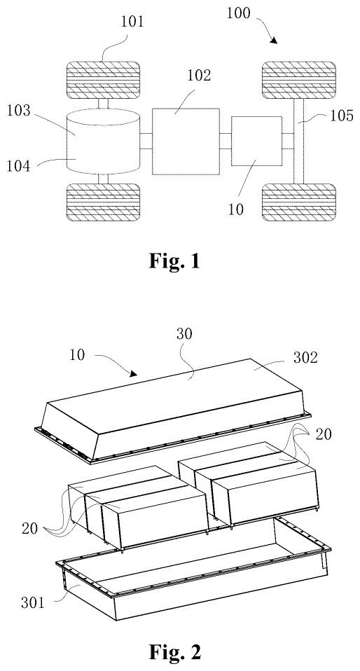

FIG. 1 to FIG. 6 illustrate configurations of an electric apparatus, a battery, a battery cell, an electrode assembly, and a current collector in some embodiments of the present application.

The present application will described below with reference to FIG. 1 to FIG. 6.

FIG. 1 exemplarily illustrates a configuration of an electric apparatus 100. With reference to FIG. 1, an electric apparatus 100 is an apparatus using a battery cell 20 as a power source, which includes a battery 10 or a battery cell 20. The battery cell 20 is configured to provide power to the electric apparatus 100. Specifically, the electric apparatus 100 includes a body 105 and a battery cell 20. The battery cell 20 is arranged on the body 105 and provides power to the body 105.

The electric apparatus 100 may be various electric devices such as a mobile phone, a tablet, a notebook computer, an electric toy, an electric tool, a battery vehicle, an electric automobile, a ship, a spacecraft, etc. The electric toys may include stationary or mobile electric toys, such as gaming machines, electric car toys, electric boat toys, electric airplane toys, and the like. Spacecraft may include aircraft, rockets, space airplanes and space vehicles, and the like.

The electric apparatus 100 includes a power source that includes a battery 10. The battery 10 provides a driving force for the electric apparatus 100. In some embodiments, the driving force of the electric apparatus 100 is all electrical energy, in which case the power source includes only the battery 10. In other embodiments, the driving force of the electric apparatus 100 includes electrical energy and other sources of energy (for example, mechanical energy), in which case the power source includes the battery 10 and other devices such as an engine.

The case where the electric apparatus 100 is a vehicle 101 is taken as an example. With reference to FIG. 1, in some embodiments, the electric apparatus 100 is a new energy vehicle such as a pure electric vehicle, a hybrid automobile or an extended range automobile, which includes a power apparatus 103 such as the battery 10, a controller 102 and a motor 104. The battery 10 is electrically connected to the power apparatus 103 such as the motor 104 via the controller 102, so that the battery 10 can supply power to the power apparatus 103 such as the motor 104 under the control of the controller 102.

As can be seen, the battery 10 is an important component of the electric apparatus 100.

FIG. 2 exemplarily illustrates the configuration of the battery 10. With reference to FIG. 2, the battery 10 includes a receiving case 30 and the battery cell 20 arranged in the receiving case 30. The receiving case 30 includes a case body 301 and a case cover 302. The case body 301 and the case cover 302 are snap-fitted with each other such that a closed receiving space is formed inside the receiving case 30 to receive the battery cell 20. The number of the battery cells 20 in the receiving case 30 may be at least two, so as to provide more electric power to meet a higher demand for use. The battery cells 20 of the battery 10 may be electrically connected in series, parallel, or series-parallel to achieve greater capacity or power. It will be appreciated that a simplified depiction of battery cell 20 is used in FIG. 2.

As can be seen, the battery cell 20 is the smallest battery unit for providing electric power, which is a core component of the electric apparatus 100 and the battery 10. The performance of the battery cell 20 directly affects the performance of the electric apparatus 100 and the battery 10. Improvement of the safety performance of the battery cell 20 is advantageous in improving the performance of the electric apparatus 100 and the battery 10.

The battery cell 20 may be various types of battery cells such as a lithium ion battery, which may be of various shapes such as a square or a cylindrical shape.

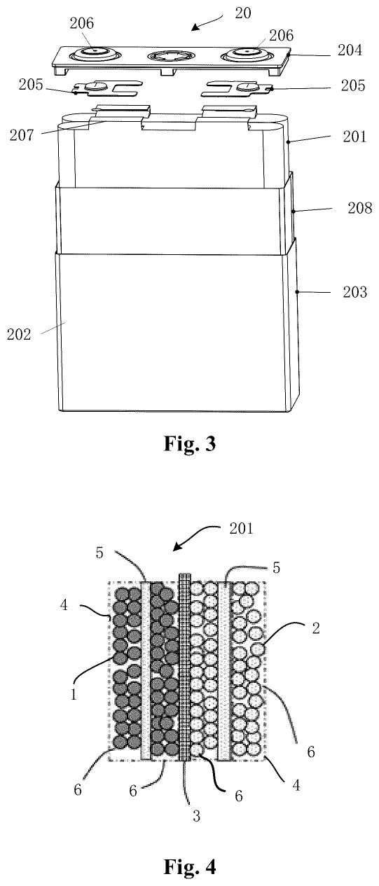

FIG. 3 exemplarily illustrates the configuration of the battery cell 20. With reference to FIG. 3, the battery cell 20 includes a housing 202, an electrode assembly 201, adaptors 205, electrode terminals 206, and a spacer 208.

The housing 202 is configured to receive the electrode assembly 201 and the like, to provide protection for the electrode assembly 201 and the like. The housing 202 includes a casing 203 and an end cap 204. The end cap 204 covers an end opening of the casing 203 such that the inside of the housing 202 forms a closed space for receiving the electrode assembly 201 and the like.

The electrode assembly 201 is configured to generate electric power. The electrode assembly 201 is arranged inside the housing 202 and supplies electric power by electrochemically reacting with an electrolyte injected into the housing 202. The number of electrode assemblies 201 in a battery cell 20 may be one, two, or more according to actual usage requirements. The electric power generated by the electrode assembly 201 is transmitted outwardly through a tab 207.

Tabs 207 are portions of a positive electrode sheet and a negative electrode sheet of the electrode assembly 201 that are not coated with an active material 6. The tabs 207 extend outward from portions of the positive and negative electrode sheets coated with the active material 6, and are electrically connected to an external circuit through the adaptors 205 and the electrode terminals 206, so as to realize the outward transfer of electric power. The tab 207 of the positive electrode sheet is referred to as a positive tab, and the tab 207 of the negative electrode sheet is referred to as a negative tab.

The adaptors 205 are arranged in the housing 202 and are positioned between the tabs 207 of the electrode assembly 201 and the electrode terminals 206. The adaptor 205 is configured to realize an electrical connection between the electrode assembly 201 and the electrode terminal 206, to transfer the electrical power generated by the electrode assembly 201 to the electrode terminal 206. The adaptor 205 corresponding to the positive tab is referred to as a positive adaptor, and the adaptor 205 corresponding to the negative tab is referred to as a negative adaptor.

The electrode terminals 206 are electrically connected to the electrode assembly 201 through the adaptors 205, and are configured to be connected to an external circuit to transfer electric power generated by the electrode assembly 201 to the outside of the battery cell 20. The electrode terminal 206 corresponding to the positive tab is referred to as a positive terminal, and the electrode terminal 206 corresponding to the negative tab is referred to as a negative terminal.

A spacer 208 is arranged in the housing 202 and is between the electrode assembly 201 and the casing 203. The spacer 208 is configured to insulate the electrode assembly 201 from the casing 203, to prevent a short circuit between the electrode assembly 201 and the casing 203.

It can be seen that, the electrode assembly 201 is an important component of the battery cell 20 and is the key for the battery cell 20 to be able to supply electric power.

FIG. 4 further illustrates the configuration of the electrode assembly 201. With reference to FIG. 4, the electrode assembly 201 includes electrode sheets 4, which are two electrode sheets 4 of opposite polarities, including a positive electrode sheet 1 and a negative electrode sheet 2. The positive electrode sheet 1 and the negative electrode sheet 2 are stacked or wound together. A diaphragm 3 is arranged between the positive electrode sheet 1 and the negative electrode sheet 2, which separates the positive electrode sheet 1 and the negative electrode sheet 2.

As illustrated in FIG. 4, each of the positive electrode sheet 1 and the negative electrode sheet 2 includes an active material 6 and a current collector 5. The active material 6 is coated on the current collector 5, and is configured to electrochemically react with the electrolyte in the housing 202 to produce electrical power, so that a charging process or a discharging process is realized. As can be seen in FIG. 4, in some embodiments, the two opposite surfaces of the current collector 5 are coated with the active material 6.

The active materials 6 on the positive electrode sheet 1 and the negative electrode sheet 2 are different, so that the positive electrode sheet 1 and the negative electrode sheet 2 have opposite polarities. For example, in some embodiments, the active material 6 on the positive electrode sheet 1 includes LiCoO2 (lithium containing cobalt dioxide) particles, and the active material 6 on the negative electrode sheet 2 includes SnO2 (tin dioxide) particles.

In the electrode assembly 201, the current collector 5 functions not only to carry the active material 6, but also to collect the electric current generated by the electrochemical reaction to form a large electric current to be outputted. The current collector 5 is an indispensable component of the battery cell 20, and is also an important factor affecting the operational safety of the battery cell 20.

In the related art, the current collector 5 is generally made of a metal material. For example, the current collector 5 of the positive electrode sheet 1 is generally made of an aluminum foil, and the current collector 5 of the negative electrode sheet 2 is generally made of a copper foil. However, the current collector 5 of such metal material is difficult to prevent a thermal runaway when the battery cell 20 is short-circuited, which limits the improvement of the safety performance of the battery cell 20.

The thermal runaway of the battery cell 20 often results from a violent chemical reaction or an electrochemical reaction within the battery cell 20. When the diaphragm 3 in the battery cell 20 is damaged due to internal foreign matters (such as metal particles, burrs on the positive and negative electrode sheets, or metal lithium dendrites precipitated during the use of the battery, etc.) or external punctures, the positive and negative electrode sheets on both sides of the damaged portion may be conducted, and a short circuit may occur. When the short-circuit occurs, the short-circuit current may cause a sharp increase in temperature and cause a more violent reaction, which diffuses to other portions and causes a thermal runaway, thus causing fire or explosion accidents and seriously threatening the personal safety of users.

Due to the high melting point of the metal material, the current collector 5 made of the metal material is not easily melted. Therefore, when the short-circuit occurs, the current collector 5 is not yet melted, and other components of the battery cell 20, such as the active material 6 and the diaphragm 3, have failed. In this case, the current collector 5 cannot block the current transmission and cannot prevent the thermal runaway from occurring, thereby affecting the safety performance of the battery cell 20.

In response to the above situation, the present application improves the configuration of the current collector 5 to improve the safety performance of the current collector 5, the electrode assembly 201, the battery cell 20, the battery 10 and the electric apparatus 100.

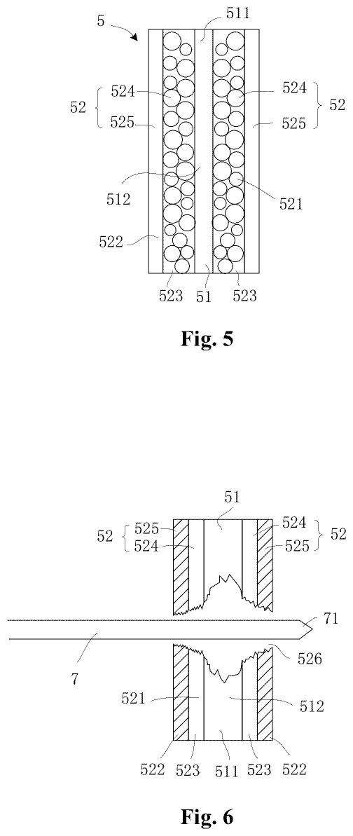

FIG. 5 to FIG. 6 exemplarily illustrate the configuration of the current collector 5.

With reference to FIG. 5 and FIG. 6, the current collector 5 provided in an embodiment of the present application includes a support layer 51 and a conductive layer 52. The conductive layer 52 is arranged on at least one of two opposite sides of the support layer 51. When the support layer 51 is heated and shrinks, the conductive layer 52 shrinks with the support layer 51 to form a hole 526 around the heated portion. The conductive layer 52 includes a first conductive layer 524, which is a granular conductive layer 521, in contact with the support layer 51.

It can be seen that, in an embodiment of the present application, the current collector 5 is no longer a single-layer metal foil structure, but becomes a structure that includes at least two layers including the support layer 51 and the conductive layer 52.

Since the melting point of the support layer 51 is low, the support layer 51 may melt when heated, driving the conductive layer 52 to shrink with the support layer 51. The hole 526 is formed around the heated portion. Therefore, when a short circuit occurs during the operation of the battery cell 20, the support layer 51 can cut off the failure circuit by driving the conductive layer 52 to shrink with it due to the high temperature at the failure position, to form the hole 526 around the failure position, so as to prevent the occurrence of a thermal runaway. With reference to FIG. 6, when the hole 526 is formed, there is no more conductor around the short-circuit initiating piece 7 (for example, a puncture needle 71, a metal particle or a burr) causing the short-circuit. The short-circuit initiating piece 7 can no longer be in contact with the conductor. Therefore, the circuit is cut off, the conduction between the positive electrode sheet 1 and the negative electrode sheet 2 due to the breakage of the diaphragm 3 can be prevented, and the local heat can be prevented from diffusing to other portions. Thus, the thermal runaway can be prevented.

Furthermore, since in this embodiment of the present application, the first conductive layer 524 of the conductive layer 52 that is in contact with the support layer 51 is the granular conductive layer 521, the granular conductive layer 521 is more easily shrunk with the support layer 51 when the support layer 51 is heated and shrinks than other conductive structures. Therefore, the circuit is more rapidly cut off and a thermal runaway is prevented more timely in the event of a short-circuit accident, so that the safety performance can be improved more effectively.

It can be seen that, by configuring the current collector 5 to include the support layer 51 and the conductive layer 52 and configuring the first conductive layer 524 of the conductive layer 52, which is in contact with the support layer 51, as the granular conductive layer 521, a thermal runaway can be prevented more efficiently and reliably, so that an effective improvement in safety performance can be achieved.

The granular conductive layer 521 may be composed of conductive particles of various metals or nonmetals. For example, with reference to FIG. 5, the granular conductive layer 521 includes a metal particle layer 523.

Since metal has good electrical conductivity, when the granular conductive layer 521 includes the metal particle layer 523, the electrical conductivity of the current collector 5 can be taken into account while a thermal runaway is effectively prevented, so that the current collector 5 has good electrical conductivity and can efficiently conduct electricity in a normal operation state without a short circuit.

As an example of the metal particle layer 523, the metal particle layer 523 includes a copper particle layer, an aluminum particle layer, a gold particle layer, a silver particle layer, or an alloy particle layer. The metal material such as copper, aluminum, gold, silver or an alloy is a metal material having good electrical conductivity, and therefore the electrical conductivity of the current collector 5 can be effectively improved.

In some embodiments, a resistivity of an alloy in the alloy particle layer is less than or equal to 30·10⁻⁰ Ω·m (ohm-meter). As such, the alloy particle layer is more conductive and may provide the current collector 5 with a better conductivity performance.

The first conductive layer 524 and the support layer 51 may be combined in various manners. As an example, the first conductive layer 524 may be sprayed on the support layer 51.

The spraying manner is more suitable for the granular state of the granular conductive layer 521 in the first conductive layer 524, so that the granular conductive layer 521 can be easily composited on the support layer 51. After the spraying, the granular conductive layer 521 can be firmly attached to the support layer 51. In one aspect, the support layer 51 can easily drive the granular conductive layer 521 to melt and shrink with it when the support layer 51 locally melts, so that the current collector 5 can easily cut off the circuit when a short-circuit accident occurs. In another aspect, it is also advantageous to prevent the granular conductive layer 521 from accidentally falling off when in anon-short circuit state. This allows the current collector 5 to more reliably collect and transfer current during normal operation.

In addition, with reference to FIG. 5, in some embodiments, the conductive layer 52 includes not only the first conductive layer 524, but also a second conductive layer 525 that is electrically connected to a surface of the granular conductive layer 521 facing away from the support layer 51.

Since the second conductive layer 525 can further improve the ability of the conductive layer 52 to conduct electricity, further adding the second conductive layer 525 on the basis of the first conductive layer 524 can more effectively improve the ability to conduct electricity of the current collector 5.

The second conductive layer 525 and the first conductive layer 524 may be combined in various manners. As an example, the second conductive layer 525 may be bonded to the first conductive layer 524. For example, the second conductive layer 525 may be bonded to the first conductive layer 524 with a conductive agent and an adhesive. On this basis, it is easy to connect the first conductive layer 524 to the second conductive layer 525, and the connection firmness is strong. At the same time, the electrical connection relationship between the second conductive layer 525 and the first conductive layer 524 is easy to realize.

In addition, the second conductive layer 525 may have various structures. For example, with reference to FIG. 5, in some embodiments, the second conductive layer 525 includes a graphite layer 522. Because graphite is much more conductive than other non-metallic conductive materials, configuring the second conductive layer 525 to include the graphite layer 522 may more effectively improve the conductivity performance of conductive layer 52.

In some embodiments, a conductivity of conductive layer 52 is 10⁴˜10⁵ S/cm (Siemens per centimeter). In this case, the conductive layer 52 can better satisfy the conductivity requirements of the current collector 5, and can effectively prevent the battery cell from generating excessive heat during a conventional charging or a discharging process.

In the above embodiments, the support layer 51 is configured to support the conductive layer 52, and in the event of a short-circuit accident, to cause the conductive layer 52 to shrink with it to cut off the failure circuit and prevent a thermal runaway.

A melting point of the support layer 51 may be less than or equal to 120° C. On this basis, the support layer 51 is more likely to melt and shrink before other portions are melted, cutting off the failure circuit. Therefore, a thermal runaway can be more reliably prevented and the safety performance can be more effectively improved.

In some embodiments, the support layer 51 is made of an organic polymer material such as polyethylene, polypropylene, or polyurethane. The organic polymer material such as polyethylene, polypropylene or polyurethane has the characteristics that the melting point is low and the heated portion can rapidly shrink and collapse when heated locally. Therefore, the support layer 51 made of the organic polymer material can rapidly cut off the failure circuit when necessary, prevent a thermal runaway and improve the safety performance.

In addition, the support layer 51 may have various shapes, for example, a granular shape or a non-granular shape. For example, with reference to FIG. 5, the support layer 51 is in a form of a film, in which case the support layer 51 is a support film 511. The support film 511 can better support the conductive layer 52, so that the current collector 5 has not only good safety performance but also strong structural stability.

With further reference to FIG. 5, in some embodiments, the support layer 51 is a polyethylene film 512. At this time, the support layer 51 is a support film 511 made of a polyethylene material, which not only can effectively prevent a thermal runaway, but also improve bending resistance of the current collector 5.

Next, the embodiment shown in FIG. 5 will be explained.

As shown in FIG. 5, in this embodiment, the current collector 5 includes the support layer 51 and two conductive layers 52 arranged on two opposite sides of the support layer 51. Each of the conductive layers 52 includes the first conductive layer 524 and the second conductive layer 525.

The support layer 51 is specifically the polyethylene film 512. The first conductive layer 524 is specifically the metal particle layer 523. The second conductive layer 525 is specifically the graphite layer 522.

A polyethylene film 512 is positioned in the middle. The two opposite sides of the polyethylene film 512 are both sprayed with a metal particle layer 523. An outer surface of the metal particle layer 523 on each side is bonded with a graphite layer 522. The graphite layer 522 is bonded to a surface of the metal particle layer 523 facing away from the polyethylene film 512 by a conductive agent and an adhesive. The surface of the graphite layer 522 facing away from the metal particle layer 523 becomes the outer surface of the conductive layer 52 for carrying the active material 6. In the fabrication of the electrode sheet 4, the active material 6 is coated on the outer surface of the graphite layer 522, so that the surfaces of the current collector 5 on both opposite sides are coated with the active material 6.

On the basis of the above arrangement, the current collector 5 forms a five-layer structure, in which the polyethylene film 512 is in the middle, and the metal particle layers 523 as well as the graphite layers 522 are symmetrically arranged on both sides of the polyethylene film 512.

The metal particle layer 523 and the graphite layer 522 mainly function to conduct electricity. The conductivity of the conductive layer 52 composed of the metal particle layer 523 and the graphite layer 522 can be maintained within the range of 10⁴˜10⁵ S/cm (Siemens per centimeter), which can better meet the conductivity requirements of the current collector 5, and effectively prevent the battery cell 20 from generating excessive heat during a conventional charging or discharging process due to the great electric resistivity of the current collector 5.

The polyethylene film 512 supports the metal particle layer 523 and the graphite layer 522, improves the bending resistance of the current collector 5, and improves the safety performance of the current collector 5.

How the safety performance of the current collector 5 in this embodiment is improved is explained with respect to an example of a puncture failure shown in FIG. 6. A simplified drawing of the metal particle layer 523 is shown in FIG. 6.

With reference to FIG. 6, in combination with FIG. 4, when the puncture needle 71 pierces the positive electrode sheet, the negative electrode sheet and the diaphragm 3, the puncture needle 71 conducts the current collector 5 of the positive electrode sheet 1 and the current collector 5 of the negative electrode sheet 2. An extremely high current passes through the failure position, resulting in an extremely high temperature at the failure position. In this case, if the current collector 5 is a metal current collector, the melting point of the metal current collector is higher than that of other materials. Therefore, the active material 6 or other components such as the diaphragm 3 may be caused to fail, resulting in a thermal runaway. The current collector 5 in this embodiment is no longer a single-layer metal foil structure, but instead it is a five-layer structure including the polyethylene film 512, the metal particle layers 523 and the graphite layers 522. The portion of the polyethylene film 512 around the puncture needle 71 for supporting the metal particle layers 523 and the graphite layers 522 can rapidly melt and shrink in the increasing process of the temperature at the failure position, driving the metal particle layers 523 and the graphite layers 522 on the corresponding portions of the polyethylene film 512 to shrink with it, so that the portion of the current collector 5 around the puncture needle 71 rapidly collapses to form the hole 526. The formed hole 526 can cut off the electrical connection between the puncture needle 71 and the current collector 5. The failure circuit is cut off. Therefore, the further diffusion of the electrochemical reaction inside the battery and the internal short circuit can be effectively prevented, and the thermal runaway can be prevented, so that the safety performance can be effectively improved.

Since the metal particle layer 523 is granular, the bonding tightness between the metal particles is low as compared with the case of non-granular metal foil or the like. The connection between metal particles are easily broken at a high temperature. When the polyethylene film 512 is melted and shrinks, the metal particle layer 523 can easily shrink with it, facilitating the current collector 5 to cut off the failure circuit more rapidly. Therefore, it is advantageous for a more reliable prevention of a thermal runaway, thereby more effectively improving the safety performance.

The current collector 5 may be the current collector 5 of the positive electrode sheet 1 or the current collector 5 of the negative electrode sheet 2. When the current collector 5 is the current collector 5 of the positive electrode sheet 1, the metal particle layer 523 may be an aluminum particle layer made of powdered aluminum. When the current collector 5 is the current collector 5 of the negative electrode sheet 2, the metal particle layer 523 may be a copper particle layer made of powdered copper.

The foregoing is illustrative of the present application and is not to be construed as limiting thereof. Any modifications, equivalents and improvements that fall within the gist and scope of the application are intended to be included in the protection scope of the present application.

What is claimed is:

1. A current collector comprising:
a support layer; and
a conductive layer on at least one of two opposite sides of the support layer,
wherein when the support layer is heated and shrinks, the conductive layer shrinks with the support layer to form a hole around a heated portion,
the conductive layer comprises a first conductive layer in contact with the support layer, and the first conductive layer is a granular conductive layer.

2. The current collector according to claim 1, wherein the conductive layer is configured so that:
the granular conductive layer comprises a metal particle layer;
the conductive layer comprises a second conductive layer electrically connected to a surface of the granular conductive layer facing away from the support layer;
a conductivity of the conductive layer is 10⁴˜10⁵ S/cm; and/or
the first conductive layer is sprayed on the support layer.

3. The current collector according to claim 2, wherein the metal particle layer comprises a copper particle layer, an aluminum particle layer, a gold particle layer, a silver particle layer, or an alloy particle layer.

4. The current collector according to claim 3, wherein a resistivity of an alloy in the alloy particle layer is less than or equal to 30·10⁻⁹ Ω·m.

5. The current collector according to claim 2, wherein the second conductive layer is bonded to the first conductive layer; and/or, the second conductive layer comprises a graphite layer.

6. The current collector according to claim 3, wherein the second conductive layer is bonded to the first conductive layer; and/or, the second conductive layer comprises a graphite layer.

7. The current collector according to claim 4, wherein the second conductive layer is bonded to the first conductive layer; and/or, the second conductive layer comprises a graphite layer.

8. The current collector according to claim 1, wherein the support layer is configured so that:
a melting point of the support layer is less than or equal to 120° C.;
the support layer is a support film; and/or
the support layer is made of an organic polymer material.

9. The current collector according to claim 2, wherein the support layer is configured so that:
a melting point of the support layer is less than or equal to 120° C.;
the support layer is a support film; and/or
the support layer is made of an organic polymer material.

10. The current collector according to claim 3, wherein the support layer is configured so that:
a melting point of the support layer is less than or equal to 120° C.;
the support layer is a support film; and/or
the support layer is made of an organic polymer material.

11. The current collector according to claim 4, wherein the support layer is configured so that:
a melting point of the support layer is less than or equal to 120° C.;
the support layer is a support film; and/or
the support layer is made of an organic polymer material.

12. The current collector according to claim 5, wherein the support layer is configured so that:
a melting point of the support layer is less than or equal to 120° C.;
the support layer is a support film; and/or
the support layer is made of an organic polymer material.

13. The current collector according to claim 8, wherein the support layer is a polyethylene film.

14. An electrode sheet comprising an active material and further comprising the current collector according to claim 1, the active material being arranged on a surface of the current collector.

15. An electrode assembly comprising:
a positive electrode sheet; and
a negative electrode sheet;
wherein the positive electrode sheet and/or the negative electrode sheet are the electrode sheet according to claim 14.

16. A battery cell comprising a housing and further comprising the electrode assembly according to claim 15, the electrode assembly being arranged in the housing.

17. A battery comprising a receiving case and further comprising the battery cell according to claim 16, the battery cell being arranged in the receiving case.

18. An electric apparatus comprising the battery according to claim 17.

19. An electric apparatus comprising the battery cell according to claim 16, the battery cell being configured to provide power to the electric apparatus.
